(19) United States
(12) Patent Application Publication
(10) Pub. No.: US 2025/0130440 A1
(43) Pub. Date: Apr. 24, 2025

(54) AN EYEWEAR APPARATUS

(71) Applicant: Pixieray Oy, Espoo (FI)

(72) Inventors: Timo Yliluoma, Helsinki (FI); Otto Huittinen, Vantaa (FI)

(73) Assignee: Pixieray Oy, Espoo (FI)

(21) Appl. No.: 18/489,089

(22) Filed: Oct. 18, 2023

(51) Int. Cl. G02C 11/00; G02C 5/22

(52) U.S. Cl. CPC G02C 11/10; G02C 5/2227

(57) ABSTRACT

The present disclosure provides an eyewear apparatus with a frame supporting at least one optical element and a temple, which housed power source that supplies electricity to electrical component that is associated with either of optical element, frame or temple which is connected with frame through hinge mechanism comprising has a first pin and a concentrically disposed second pin at a distance, forming a volume between first pin and second pin, wherein the first volume provides a passage of electrical conductor that facilitates electrical connectivity between the power source and electrical component.

### TECHNICAL FIELD

The present disclosure generally relates to an eyewear and particularly to an electronic eyewear. The disclosure further relates to an electrical conductor housed in eyewear to enable supply of power from a power source to an electrical component.

### BACKGROUND

Eyewear has conventionally been used to aid or correct vision, protect eyes from harmful radiation or physical debris, and as a fashion accessory. In recent times, advancements in technology have led to the integration of electronic components into eyewear to provide additional functionalities such as digital displays, augmented reality (AR), virtual reality (VR), real-time communication, and health monitoring among others. However, integrating such electronics within eyewear while maintaining aesthetics, comfort, and functionality poses significant challenges.

One of the challenges is housing of necessary power sources and ensuring reliable electrical connections between the power sources and the electronic components, especially while preserving the eyewear's design flexibility and structural integrity. Conventionally, external wiring is used to provide electrical connection between the power source and the electronic components. The external wire potentially affects durability and user-friendly operation of the eyewear due to discomfort caused by snagging on hair or skin, or by creating pressure points on the wearer's head, exposure to environmental factors such as moisture, dust, and temperature extremes, which could adversely affect their performance thereby reducing the reliability and lifespan of the eyewear, snagging of cable surrounding objects such as hinge to cause damage other components of eyewear.

In light of the above discussion, there is an evident need for an eyewear system that seamlessly integrates electronic components, power sources, and electrical conductors within a sleek, user-friendly design.

### SUMMARY

An aim of the present disclosure is to provide an eyewear apparatus comprising an electrical conductor to enable supply of electricity to an electrical component, from power source housed inside a temple as defined in the appended independent claims to which reference is made to. The electrical conductor passes through volume provided between pins of a hinge that is housed in the eyewear. Such passing of electric conductor through the volume shields from external damages and ensures unimpeded mechanical hinge functionality. Moreover, aesthetic appeal also increases by concealing the electrical conductor within the hinge or temple. Additionally, the structural space is utilized around the hinge, contributing to a more compact, balanced, and aesthetically pleasing eyewear. Advantageous features are set out in the appended dependent claims.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of an exploded view of an eyewear apparatus according to one embodiment of the present disclosure;

FIG. 2 is an illustration of an exploded view of an eyewear apparatus as per one embodiment of the present disclosure; and

FIG. 3 an illustration of an exploded view of an eyewear apparatus in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, the present disclosure provides an eyewear apparatus comprising:
a frame;
at least one optical element supported by the frame;
a temple;
at least one electrical component is associated with at least one of: the at least one optical element, the frame;
a power source housed inside the temple, wherein the power source supplies electricity to the at least one electrical component;
an electrical conductor connects the power source to the at least one electrical component; and
a first hinge couples the frame and the temple, wherein the first hinge provides a first rotation point to allow rotation of the temple with respect to the frame,
wherein the first hinge comprises a first pin and a second pin, wherein the second pin is disposed concentrically to the first pin at a distance from the first pin, and wherein a volume is provided between a first end of the first pin and a second end of the second pin, wherein the first end of the first pin and the second end of the second pin are facing towards each other, and wherein the electric conductor passes through the volume.

The term “eyewear apparatus” as used throughout the present disclosure refers to an arrangement of electrical and/or mechanical components that is worn around eyes of a user of the eyewear apparatus (referred to as “wearer” throughout a remainder of the present disclosure). Such an eyewear apparatus is employed, for example, to correct a vision disorder, including but not limited to, myopia, hyperopia, astigmatism, presbyopia and the like, such as, by enabling appropriate refraction, reflection, diffraction or transmission of light towards the eyes of the wearer wearing the eyewear apparatus. Further, the eyewear apparatus is used to provide protection to the eyes of the wearer from ambient conditions such as sunlight, ultraviolet radiation, blue light associated with computing devices, dust, chemical fumes and such like. Optionally, the eyewear apparatus enables display of information to the eyes of the wearer. More optionally, the eyewear apparatus is equipped with sensors to detect environmental conditions, physiological conditions associated with the wearer or to gather data for operation of the eyewear apparatus.

The eyewear apparatus comprises a frame. The term “frame” as used throughout the present disclosure relates to a mechanical component of the eyewear apparatus that acts as a stable base to enable the wearer to wear the eyewear apparatus around the eyes. The frame is fabricated, for example, with cellulose acetate, propionate plastic, nylon-based plastic, polyamide, epoxy resin, carbon fiber, metal, metal alloy and the like. In one example, the frame comprises a left rim corresponding to a left eye of the wearer and a right rim corresponding to the right eye of the wearer. Further, the left rim and the right rim are separated by a bridge that is arranged on nose of the wearer when the eyewear apparatus is worn by the wearer. In another example, the frame comprises a single rim having a width equal to or more than a binocular distance of the wearer.

The eyewear apparatus comprises an optical element supported by the frame. The term “optical element” as used throughout the present disclosure refers to a mechanical or electromechanical component that alters a property of light transmitted from outside the optical element towards the eyes of the wearer, such as direction, intensity, polarization, phase, or wavelength through, for example, reflection, refraction, diffraction, or transmission of the light through the optical element. Such an optical element can comprise a single optical element (such as a lens, mirror, grating, prism, light filter, beam splitter and fiber optic device) having a width more than or equal to the binocular distance of the wearer. In one example, the optical element comprises a left optical element, such as first a lens, arranged in travel path of light towards the left eye of the wearer and a right optical element, such as a second lens, arranged in travel path of light towards the right eye of the wearer. Optionally, the optical element comprises a display device, such as a display screen capable of displaying digital information to the wearer. Such a display screen is implemented to be substantially transparent to enable transmission of ambient light towards the eyes of the wearer in addition to displaying of the information on the display screen. The optical element is supported by the frame, for example, by employing a permanent, skin-friendly adhesive to attach the optical element to the frame. Alternatively, the frame is fabricated to grip the optical element, such as, by fabricating the rim (or the left and right rims) of the frame around the optical element.

The eyewear apparatus comprises a temple. The term “temple” as used throughout the present disclosure relates to an elongate mechanical or electromechanical component that is disposed towards at an extreme left end and/or an extreme right end of the frame. Such temples are arranged over ears of the wearer when the eyewear apparatus is worn by the wearer. The eyewear apparatus comprises a left temple corresponding to a left side of the frame such that the left temple is received over left ear of the wearer. Such a left temple enables the eyewear apparatus to be balanced over the left ear of the wearer. Further, the eyewear apparatus comprises a right temple corresponding to a right side of the frame such that the right temple is received over right ear of the wearer. The right temple enables the eyewear apparatus to be balanced over the right ear of the wearer. Further, arrangement of the left temple and the right temple on two opposite sides of the frame ensures a symmetrical and balanced design of the eyewear apparatus. Such symmetrical and balanced design provides consistent weight distribution, improving wearability and comfort for the wearer during use of the eyewear apparatus.

The eyewear apparatus comprises at least one electrical component arranged on at least one of: the at least one optical element, the frame. The electrical component is arranged on the optical element and/or the frame such that the electrical component receives an input, such as electricity, to enable corresponding operation of the optical element and/or the frame. For example, the optical element is implemented as a light source. Such a light source is an electronic component capable of receiving an instruction to emit a light pulse and correspondingly, emit the light pulse. Optionally, the light source is an infrared light-emitting diode (referred to as “IR LED” throughout a remainder of the present disclosure) that is integrated within the optical element and capable of emitting infrared light that is invisible to the wearer and therefore, does not inhibit a sight of the wearer during usage of the eyewear apparatus. In another example, the electrical component is a light sensor arranged on the frame. In such an example, the light sensor is capable of receiving emitted or reflected light (such as, light emitted by the light source arranged on the optical element) to enable determination of at least one characteristic associated with the emitted or reflected light.

The eyewear apparatus comprises a power source housed inside the temple. The term “power source” as used throughout the present disclosure refers to an electrical device capable of supplying electricity to one or more components of the eyewear apparatus to enable operation of the corresponding components. Optionally, the power source is rechargeable to allow connection of the power source to an external power supply, such as an alternating current power supply, to enable recharging of the power source for repeated and extended operation of the eyewear apparatus. For example, the power source is implemented as a rechargeable battery, including but not limited to, a Li-ion battery, NiCd battery, NiMH battery and the like. The power source is to be employed to supply electricity to the at least one electrical component. The power source is electrically connected to the electrical component, such as, by employing an electrical conductor (discussed below) to enable transmission of electricity from the power source to the electrical component. For example, when the power source is implemented as the rechargeable battery and the electrical component is implemented as the light source, the power source supplies direct current to the light source to enable emission of light pulses by the light source. In another example, when the electrical component is implemented as the light sensor, the power source supplies direct current to the light sensor to enable detection of light by the light sensor.

The eyewear apparatus comprises an electrical conductor connecting the power source to the at least one electrical component. The electrical conductor enables conduction of electricity, such as direct current, from the power source to the electrical component. In one example, the electrical conductor is implemented using an elongate metal conductor having less thickness compared to a width of the metal conductor such that the electrical conductor has a flat or “tape-like” form factor. Such a flat form factor of the electrical conductor enables arrangement of the electrical conductor across small volumes within the eyewear apparatus, thereby, enabling the apparatus to be compact and lightweight. In one example, the electrical conductor is fabricated using copper, silver, gold, platinum or a similar metal having high electrical conductivity. It will be appreciated that a selection of material employed for fabrication of the electrical conductor impacts a functionality and efficiency of the eyewear apparatus. For example, electrical conductors coated with electric insulators are commercially available as electric cables, making such electrical conductors cost-effective, easy to install and safe due to the coating of electrical insulators preventing unwanted electrical discharges. However, flexible printed circuit boards (or “flexible PCBs”) offer compact design, high customizability, and durability, making such flexible PCBs suitable for applications requiring lightweight and durable electrical conductors, such as the eyewear apparatus. In one example, the flexible PCBs are fabricated using graphene sheets. It will be appreciated that flexible PCBs fabricated using graphene sheets are associated high electrical conductivity, thin form factor, flexibility, transparency, and high mechanical strength, thereby, enhancing performance, aesthetics and durability of the eyewear apparatus. For example, the transparency associated with the flexible PCB fabricated using graphene sheets allows for high electrical conductivity without obstructing vision of the wearer. The eyewear apparatus comprises a first hinge coupling the frame and the temple, the first hinge enabling a first rotation point and configured to allow rotation of the temple with respect to the frame. The term “first hinge” as used throughout the present disclosure relates to a mechanical or electromechanical component that enables relative rotation (such as, by pivoting) between two components that are connected to each other via the first hinge. For example, the first hinge refers to a left hinge connecting the left temple of the eyewear apparatus to the extreme left end of the frame such that the first hinge enables relative rotation of the left temple with respect to the frame. The term “first rotation point” as used throughout the present disclosure relates to a pivot point associated with rotation (such as, by pivoting) of the temple with respect to the frame. The first hinge enables the first rotation point and is configured to allow rotation of the temple with respect to the frame such that the rotation of the corresponding temple (such as the left temple) with respect to the frame enables the temple to be closed with respect to the frame. Further, when the temple is closed with respect to the frame, the eyewear apparatus occupies a lower overall volume as compared to when the temple is not closed, thereby, enabling storage of the eyewear apparatus in a compact manner. In another example, the first hinge refers to a right hinge connecting the right temple of the eyewear apparatus to the extreme right end of the frame such that the first hinge enables relative rotation of the right temple with respect to the frame.

The first hinge comprises a first pin and a second pin. The term “pin” as used throughout the present disclosure with reference to a hinge (such as the first hinge) relates to a mechanical component that enables stable connection of two other components of the eyewear system. Such pin is implemented, for example, as a solid cylindrical element, a solid conical element and the like. In one example, the first pin is a solid cylindrical element that is simultaneously received within a first hole associated with a first mechanical element and a second hole associated with a second mechanical element. Further, the first hole and the second hole are vertically aligned with respect to each other. In such an example, the first pin enables to maintain a vertical position of the first mechanical element with respect to the second mechanical element. The second pin is disposed concentrically to the first pin at a distance from the first pin. Optionally, the first pin is associated with a first longitudinal axis passing through a center of the first pin and the second pin is associated with a second longitudinal axis passing through a center of the second pin. The second pin is disposed concentrically to the first pin such that the first longitudinal axis is aligned with the second longitudinal axis to enable arrangement of the first pin to be vertically concentric to the second pin. The first pin and the second pin are disposed at the distance from each other to enable presence of a vertical gap between arrangement of the first pin and the second pin within the eyewear apparatus. Further, a volume is provided between a first end of the first pin and a second end of the second pin. For example, each of the first pin and the second pin are implemented as solid cylindrical elements. Further, the first end of the first pin refers to a lower circular surface of the first pin and the second end of the second pin refers to an upper circular surface of the second pin. The first end of the first pin and the second end of the second pin are facing towards each other. In the above example, the first pin and the second pin are arranged such that the lower circular surface of the first pin faces towards (such as, by being parallel to) the upper circular surface of the second pin. Further, the first end of the first pin and the second end of the second pin are disposed at the distance from each other such that the volume is provided between the first end and the second end. It will be appreciated that a height of the volume provided between the first end and the second end corresponds to the distance between the first end and the second end. The electric conductor passes through the volume. The power source is arranged on one side of the volume (such as, towards a rear side of the volume) and the electrical component is arranged towards another side of the volume (such as, a front side of the volume) such that the electric conductor that is connected to each of the power source and the electrical component passes through the volume. In one example, the power source is implemented as a rechargeable battery that is arranged within the temple and the electrical component is implemented as an IR LED arranged on the frame above the eyes of the wearer when the eyewear apparatus is worn by the wearer. In such an example, the first pin and the second pin are arranged between the temple and the frame, such as, within the first hinge of the eyewear apparatus such that the volume is formed within the first hinge. In such an example, the electrical conductor is connected to each of the rechargeable battery and the IR LED such that the electrical conductor passes through the first hinge. Such an arrangement of the first pin and the second pin in a dual-pin arrangement provides a redundancy feature, such as, in an event of failure of the first pin (or the second pin), the second pin (or the first pin) continues to provide necessary support and functionality to the first hinge, thereby enhancing overall durability and reliability of the first hinge as well as the eyewear apparatus. The volume provided between the first end of the first pin and the second end of the second pin is utilized, for example, to house and protect flexible elements such as wires, cables, tubes or optionally, other components (such as electrical components) of the eyewear apparatus. Such housing of the flexible elements and/or electrical components of the eyewear apparatus enables safeguarding of such components from external damage, wear, and tear, thereby, enabling to maintain integrity and functionality of the components housed with the first hinge. The volume between the first pin and the second pin also provides an organized route for disposing the flexible elements, enabling convenient and proper arrangement of the flexible elements while preventing entanglement of such flexible elements within the first hinge. The organized routing of the flexible elements enables easier maintenance and inspection of the flexible elements. The dual-pin arrangement also simplifies repair and maintenance of the eyewear apparatus, such as, by convenient removal of each of the first pin and the second pin from openings to decouple corresponding mechanical elements. The volume provided between the first pin and the second pin further allows easier access to the flexible elements and/or electrical components housed within the first hinge, such as, for repair or replacement.

In a second aspect, the present disclosure provides an eyewear apparatus comprising:
a frame;
at least one optical element supported by the frame;
a temple;
at least one electrical component is associated with at least one of: the at least one optical element, and the frame;
a power source housed inside the temple, wherein the power source supplies electricity to the at least one electrical component;
an electrical conductor connects the power source to the at least one electrical component;
a rotating member;
a first hinge couples the temple to the rotating member, wherein the first hinge provides a first rotation point to allow rotation of the temple with respect to the rotating member, and
a second hinge couples the frame to the rotating member, wherein the second hinge provides a second rotation point to allow rotation of the frame with respect to the rotating member,
wherein the first hinge comprises a first pin and a second pin, wherein the second pin is disposed concentrically to the first pin at a first distance from the first pin, and wherein a first volume is provided between a first end of the first pin and a second end of the second pin, wherein the first end of the first pin and the second end of the second pin are facing towards each other, and wherein the electric conductor passes through the first volume,
wherein the second hinge comprises a third pin and a fourth pin, wherein the fourth pin is disposed concentrically to the third pin at a second distance from the third pin, and wherein a second volume is provided between a third end of the third pin and a fourth end of the fourth pin, further wherein the third end of the third pin and the fourth end of the fourth pin are facing towards each other, and wherein the electric conductor passes through the second volume.

The eyewear apparatus comprises a rotating member. The term “rotating member” as used throughout the present disclosure relates to a mechanical or electromechanical component that is attached to one or more other components of the eyewear apparatus. The rotating member enables rotation (such as, pivoting) between the different components of the eyewear apparatus that are attached to the rotating member by providing a stable base to enable individual rotation of each component of the eyewear apparatus with respect to the rotating member. In one example, the frame and the temple are each attached to the rotating member, such as, on different sides (such as a front side and a rear side, respectively) of the rotating member. The rotating member enables independent rotation of the temple with respect to the rotating member. The rotating member also enables independent rotation of the frame with respect to the rotating member. It will be appreciated that such independent rotations of the temple and the frame, respectively, when performed with respect to the rotating member, simplifies operation and adjustment of the eyewear apparatus, increasing user-friendliness and overall user experience associated with the eyewear apparatus.

The eyewear apparatus comprises the first hinge that couples the temple to the rotating member. The first hinge provides a first rotation point to allow rotation of the temple with respect to the rotating member. The rotating member is disposed within the first hinge such that the temple is rotatably coupled to the rotating member. For example, the temple is coupled to the rear side of the rotating member. In such an example, the temple is allowed to change an angular orientation of the temple with respect to the rotating member by rotating (such as, by pivoting) with respect to the rotating member. Such rotating of the temple with respect to the rotating member is allowed about the first rotation point, such that the first rotation point provides a stable pivot point for rotation of the temple. In one example, the temple is allowed to rotate at an angle of 12°, 18°, 22°, 27°, 30°, 33°, 46°, 57°, 62°, 78°, 85°, 90° about the first rotation point. In another example, the temple is allowed to rotate at an angle of −10°, −16°, −21°, −24°, −32°, −33°, −45°, −58°, −61°, −79°, −84°, −90° about the first rotation point.

The eyewear apparatus comprises a second hinge that couples the frame to the rotating member. The second hinge provides a second rotation point to allow rotation of the frame with respect to the rotating member. The term “second hinge” as used throughout the present disclosure relates to a mechanical or electromechanical component that enables relative rotation (such as, by pivoting) between two components that are connected to each other via the second hinge. The term “second rotation point” as used throughout the present disclosure relates to a pivot point associated with rotation (such as, by pivoting) of the frame with respect to the rotating member. For example, the second hinge couples the frame to the rotating member such that the frame is allowed to independently rotate with respect to the rotating member about the second rotation point. In one example, the frame is allowed to rotate at an angle of 11°, 17°, 23°, 28°, 32°, 34°, 47°, 56°, 65°, 77°, 89°, 90° about the second rotation point. In another example, the frame is allowed to rotate at an angle of −13°, −17°, −24°, −27°, −31°, −34°, −46°, −56°, −60°, −76°, −81°, −90° about the second rotation point. Consequently, the rotating member enables independent rotation of the temple with respect to the rotating member about the first rotation point and the frame with respect to the rotating member about the second rotation point. Optionally, the second hinge is disposed parallel to the first hinge in a horizontal direction (such as, in a direction from a left side to a right side) of the eyewear apparatus. Alternatively, the second hinge is disposed at a specific angle with respect to the first hinge in the horizontal direction of the eyewear apparatus.

Such first hinge and second hinge form a dual hinge arrangement to provide two distinct points of rotation, thereby, significantly increasing flexibility of the eyewear apparatus. Such an implementation of the first hinge and the second hinge enables a more personalized fit and adjustment for different head sizes and shapes associated with different wearers, thereby, enhancing user comfort and wearability. The two distinct points of rotation also provides a broader range of adjustability to the wearer. Further, the wearer is allowed to independently adjust the frame and temple with respect to the rotating member, thereby, allowing for a more customized fit, such as, in dynamic or active scenarios (for example, when the eyewear apparatus is worn during physical exercise). The rotating member along with the dual hinge arrangement distributes mechanical stresses more evenly across the eyewear apparatus. Such an even distribution of the mechanical stresses leads to a reduction in wear and tear of the first hinge, the second hinge and the rotating member, thereby, enhancing durability and longevity of the eyewear apparatus.

The first hinge comprises a first pin and a second pin. The first pin and the second pin enable rotational coupling of the temple to the rotating member. The second pin is disposed concentrically to the first pin at a first distance from the first pin. For example, the temple comprises a top hole and a bottom hole, such that the bottom hole is disposed concentrically to the top hole along a vertical axis of the top hole. Further, the rotating member comprises an upper hole and a lower hole, such that the lower hole is disposed concentrically to the upper hole along a vertical axis of the upper hole. The top hole of the temple is aligned with the upper hole of the rotating member and the first pin is received into the aligned top hole and upper hole. The bottom hole of the temple is aligned with the lower hole of the rotating member and the second pin is received into the aligned bottom hole and lower hole. It will be appreciated that because of alignment of the vertical axes associated with each of the top hole, the upper hole, the bottom hole and the lower hole, the first longitudinal axis associated with the first pin will be in alignment with the second longitudinal axis associated with the second pin. Further, a first volume is provided between a first end of the first pin and a second end of the second pin. The first end of the first pin and the second end of the second pin are facing towards each other. For example, each of the first pin and the second pin are implemented as solid cylindrical elements. In such an example, the first end of the first pin refers to a lower circular surface of the first pin and the second end of the second pin refers to an upper circular surface of the second pin. The first pin and the second pin are arranged such that the lower circular surface of the first pin faces towards the upper circular surface of the second pin. Further, the first end of the first pin and the second end of the second pin are disposed at the first distance from each other such that the first volume is provided between the first end of the first pin and the second end of the second pin. Further, a height of the first volume provided between the first end of the first pin and the second end of the second pin corresponds to the first distance. The electric conductor passes through the first volume. For example, the power source is arranged on one side of the first volume (such as, towards a rear side of the first volume) and the electrical component is arranged towards another side of the volume (such as, a front side of the first volume) such that the electric conductor passes through the first volume and electrically connects the power source to the electrical component. In one example, the power source is implemented as a Lithium-ion (Li-ion) battery that is arranged within the temple and the electrical component is implemented as a display associated with the optical element. In such an example, the first pin and the second pin are arranged between the temple and the frame, such as, within the first hinge such that the first volume is formed within the first hinge. In such an example, the electrical conductor is connected to each of the Li-ion and the display such that the electrical conductor passes through the first hinge.

The second hinge comprises a third pin and a fourth pin. The fourth pin is disposed concentrically to the third pin at a second distance from the third pin. For example, the rotating member comprises an upper receptacle and a lower receptacle such that a vertical axis associated with the upper receptacle is in axial alignment with a vertical axis associated with the lower receptacle. Further, the frame comprises a first hole and a second hole such that a vertical axis associated with the first hole is in axial alignment with a vertical axis associated with the second hole. The first hole is aligned with the upper receptacle along the vertical axis of each of the first hole and the upper receptacle. Further, the third pin is received into the first hole aligned with the upper receptacle. The second hole is aligned with the lower receptacle along the vertical axis of each of the second hole and the lower receptacle. Moreover, the fourth pin is received into the second hole aligned with the lower receptacle. Optionally, the third pin is associated with a third longitudinal axis passing through a center of the third pin and the fourth pin is associated with a fourth longitudinal axis passing through a center of the fourth pin. It will be appreciated that because the vertical axis associated with each of the first hole, the upper receptacle, the second hole and the lower receptacle is in axial alignment with each other, the third longitudinal axis will be in axial alignment with the fourth longitudinal axis.

Moreover, a second volume is provided between a third end of the third pin and a fourth end of the fourth pin. The third end of the third pin and the fourth end of the fourth pin are facing towards each other. For example, each of the third pin and the fourth pin are implemented as solid cylindrical elements. In such an example, the third end of the third pin refers to a lower circular surface of the third pin and the fourth end of the fourth pin refers to an upper circular surface of the fourth pin. The third pin and the fourth pin are arranged such that the lower circular surface of the third pin faces towards the upper circular surface of the fourth pin. Further, the third end of the third pin and the fourth end of the fourth pin are disposed at the second distance from each other such that the second volume is provided between the third end of the third pin and the fourth end of the fourth pin. Further, a height of the second volume provided between the third end of the third pin and the fourth end of the fourth pin corresponds to the second distance. The electric conductor passes through the second volume. For example, the power source is arranged within the temple and the electrical component is arranged within the frame such that the first volume is disposed proximally to the temple and the second volume is disposed proximally to the frame. The electric conductor is connected to the power source disposed within the temple. Such an electric conductor passes from the temple through the first volume and subsequently, through the second volume until the electric conductor reaches the frame such that the electric conductor is connected to the electrical component. Consequently, the electric conductor passes from the temple to the first hinge, the second hinge and thereafter, to the frame. It will be appreciated that the first volume and the second volume formed by dual-pin arrangement associated with each of the first hinge and the second hinge provide a structured and organized route for convenient, compact and aesthetic arrangement of electrical components within the eyewear apparatus, preventing exposure of such electrical components to outside environment and/or onlookers while also protecting the electrical components from entanglement and/or damage. The dual-pin arrangement associated with each of the first hinge and the second hinge also provides a redundancy feature, such as, in case of failure of one of two pins by enabling the other pin to continue providing necessary support and functionality, thereby enhancing overall durability and reliability of the eyewear apparatus. The first volume and the second volume provide a protective housing for the electrical conductor to shield the electrical conductor from external damage, wear and tear, thereby, enabling to maintain integrity and functionality of electrical functionality of the eyewear apparatus. Further, housing of the electrical conductor within the first volume and the second volume removes a need for additional external cladding or protective housing to be provided on the eyewear apparatus, thereby, enabling the eyewear apparatus to be fabricated to be lightweight, sleeker and compact.

In a third aspect, the present disclosure provides an eyewear apparatus comprising:
a frame;
at least one optical element supported by the frame;
a temple;
at least one electrical component is associated with at least one of: the at least one optical element, and the frame;
a power source housed inside the temple, wherein the power source supplies electricity to the at least one electrical component;
an electrical conductor connecting the power source to the at least one electrical component;
a rotating member;
a first hinge couples the temple to the rotating member, wherein the first hinge provides a first rotation point to allow rotation of the temple with respect to the rotating member, and
a second hinge coupling the frame to the rotating member, wherein the second hinge provides a second rotation point to allow rotation of the frame with respect to the rotating member,
wherein the first hinge comprises a first pin and a second pin, the second pin is disposed concentrically to the first pin and at a distance from the first pin, and wherein a first volume is provided between a first end of the first pin and a second end of the second pin, wherein the first end of the first pin and the second end of the second pin are facing towards each other, and wherein the electric conductor passes through the first volume, and
wherein the second hinge comprises a third pin, and wherein the electric conductor passes around the third pin.

The second hinge is disposed, for example, parallel to the first hinge in the horizontal direction of the eyewear apparatus or at a specific angle with respect to the first hinge in the horizontal direction of the eyewear apparatus. Further, the third pin is received into the first hole aligned with the upper receptacle and the electric conductor connects the power source to the electrical component such that the electric conductor passes from the temple to the first hinge, the second hinge and then to the frame. The electric conductor passes through the first volume formed between the first pin and the second pin. Subsequently, the electric conductor passes around the third pin, such as, by partially or completely encircling the third pin prior to connection of the electric conductor to the electrical component disposed in the frame. The phrase “electric conductor passes around the third pin” refers to a configuration wherein the electric conductor, such as a wire or a cable, is routed or positioned in a manner such that the wire or cable encircles, wraps around, or is guided along a circumference (such as a curved surface of a solid cylindrical component) of the third pin. Consequently, the third pin acts as a guide or support for the electric conductor, thereby, helping to direct arrangement of the electrical conductor from the power source to the electrical component and/or maintain position of the electrical conductor within the eyewear apparatus.

In one embodiment, there is a frame attachment part fixed to the frame with the first hinge. The term “frame attachment part” as used throughout the present disclosure refers to mechanical component that is disposed with the frame. Further, movement that is transmitted to the frame attachment part from other components of the eyewear apparatus (such as the temple) is transmitted to the frame by the frame attachment part. Alternatively, movement of the frame that is transmitted to the frame attachment part is transmitted to other components of the eyewear apparatus (such as the temple). The frame attachment part provides a first cam surface. The term “first cam surface” as used throughout the present disclosure relates to a protrusion associated with the frame attachment part such that contact of the protrusion against another protruded element enables to transmit movement from the frame attachment surface to such other protruded element. The first cam surface enables smooth and controlled transmission of movement as the temple is rotated or pivoted around the about the first hinge. Such smooth and controlled transmission of movement enhances user experience for the wearer by ensuring a smooth and easy opening and closing of the temple with respect to the frame. The first cam surface also distributes mechanical stresses more evenly across the first hinge, reducing wear and tear of the first hinge over extended usage of the eyewear apparatus, consequently, increasing durability and longevity of the eyewear apparatus. The first cam surface also reduce friction during the operation of the rotation of the first hinge, leading to smoother and noiseless rotation of the first hinge, thereby, increasing user experience for the wearer.

In another embodiment, the rotating member is linking the frame attachment part and the temple together. The rotating member is fixed to the frame attachment part and provides a second cam surface. The rotating member is disposed between the frame attachment part and the temple such that movement of the first cam surface associated with the frame attachment part is transmitted to the rotating member. Further, the rotating member comprises an extended element, such that the extended element is associated with the second cam surface. The second cam surface is maintained in contact with the first cam surface such that the movement of the frame is transmitted to first cam surface and subsequently, to the second cam surface. Further, because the second cam surface is associated with the frame attachment part that is connected to the temple, the second cam surface transmits the movement to the temple. Consequently, the frame attachment part and the rotating member enable transmission of movement from the frame to the temple.

In yet another embodiment, there is a spring in connection to the rotating member for providing a spring force against the frame attachment part. For example, the spring is implemented as a helical spring that is disposed with the rotating member such that a free end of the helical spring is maintained in contact with the frame attachment part. It will be appreciated that movement of the frame that is transmitted via the frame attachment part to the spring causes compression of the spring, providing the spring force against the frame attachment part. Further, an extension of the spring causes application of the spring force against the frame attachment part, thereby, causing an overextension of the frame with respect to the temple. It will be appreciated that restoring of the overextension of the frame with respect to the temple prevents damage to the first hinge and/or the second hinge, thereby, preventing damage to the eyewear apparatus and increasing longevity and durability associated with the eyewear apparatus. The spring force also enables to maintain a position of the frame attachment part with respect to the frame and the rotating element, ensuring that the frame attachment part is retained in a desired position until manually adjusted by the wearer. Such retaining of the frame attachment part enables to ensure that the eyewear apparatus is securely and comfortably maintained in place around the eyes of the wearer. Optionally, the spring also enables to absorb and dissipate minute mechanical shocks and vibrations, thereby, increasing the durability and longevity of the eyewear apparatus by reducing wear and tear while also improving comfort for the wearer. The spring force also provides a self-returning feature to the frame attachment part such that the frame attachment part automatically returns to an original position being rotated, thereby, reducing expenditure of effort by the wearer to close the eyewear apparatus after usage of the eyewear apparatus.

In still another embodiment, the first cam surface and/or the second cam surface work against the spring force. The rotation of the frame attachment part against the rotating element in a first direction (such as, in a clockwise direction) causes overextension of the frame with respect to the temple, thereby, leading to compression of the spring and application of the spring force by the spring against the frame attachment part. The first cam surface and/or the second cam surface is disposed such that loss of the spring force during restoration of the overextension of the frame is limited by the first cam surface and/or the second cam surface, thereby, preventing the temple from snapping back to an original position of the temple against the spring force. The first cam surface and the second cam surface working against the spring force provide a controlled and smooth movement to the mechanical components, such as the frame attachment part and/or the temple. Consequently, damage to the temple and optionally, the first hinge and the second hinge is avoided, thereby, increasing longevity and durability associated with the eyewear apparatus.

In still another embodiment, the electrical conductor passes through a curved channel that extends past the first hinge and the second hinge, to minimize the bending of the electrical conductor during use. It will be appreciated that when the second hinge is disposed at the specific angle with respect to the first hinge in the horizontal direction of the eyewear apparatus, the curved channel is formed by the second volume disposed at the specific angle with respect to the first volume. The specific angle is chosen such that a curvature of the electrical conductor during connection of the electrical conductor from the power source to the electrical component is gradual, thereby, preventing application of mechanical stresses associated with formation of sudden bends on the electrical conductor. Consequently, the electrical conductor is prevented from experiencing failure during extended usage of the eyewear apparatus, such as, due to overextension of the temple with respect to the frame. It will be appreciated that such minimization of formation of sudden bends on the electrical conductor during use is important for maintaining integrity and functionality of electrical connections within the eyewear apparatus.

In a further embodiment, the curved channel is convex or concave, to support smooth bending of the electrical conductor. For example, the curved channel is associated with a convex curvature such that the electrical conductor passes from the first volume to the electrical component by encircling the second volume from outside the third pin and/or the fourth pin (such as, in a clockwise direction when the second hinge is associated with the left hinge). Alternatively, the curved channel is associated with a concave curvature such that the electrical conductor passes from the first volume to the electrical component by encircling the second volume from inside the third pin and/or the fourth pin (such as, in an anticlockwise direction when the second hinge is associated with the left hinge). Optionally, the curved channel is implemented to comprise one or more concave sections and one or more convex sections. For example, the curved channel forms a convex section around the first volume and a concave section around the second volume. The convex or concave nature of the curved channel supports smooth bending of the electrical conductor, reducing likelihood of formation of kinks, breaks, or other similar damage to the electrical conductor. Further, by minimizing sharp bends and potential damage to the electrical conductor, the curved channel helps in maintaining optimal electrical performance of the eyewear apparatus.

In a still further embodiment, a first width of the curved channel at the first rotation point is larger than a second width of the curved channel at the second rotation point. It will be appreciated that rotation of the temple with respect to the frame about the first rotation point will be associated with a higher angle of rotation (for example, due to overextension of the temple with respect to the frame) as compared rotation of the frame with respect to the rotating member about the second rotation point. Consequently, the larger first width of the curved channel at the first rotation point enables higher degree of movement of the electrical conductor within the curved channel at the first rotation point as compared to movement of the electrical conductor within the curved channel at the second rotation point, thereby, preventing damage and/or consequent breakage of the electrical conductor due to overextension of the temple with respect to the frame. Such a difference between the first width and the second width of the curved channel further enables to control a bending radius of the electrical conductor when passing from the temple to the frame, such as, during rotation of the temple with respect to the frame, thereby, ensuring that the bending of the electrical conductor remains within safe limits to prevent damage or degradation of the electrical conductor over extended usage of the eyewear apparatus.

In a still further embodiment, the eyewear apparatus comprises a charging interface, which is positioned at a first proximal end of the temple. The term “charging interface” as used throughout the present disclosure refers to an electrical component of the eyewear apparatus that enables establishing of electrical connection between the power source and an external power supply for recharging of the power source (for example, the power source implemented as a rechargeable power source). Such an electrical connection is established, for example, using a charger that is simultaneously connected to each of the charging interface and the external power supply. The charging interface optionally comprises a first contact and the second contact. The term “proximal end of the temple” as used throughout the present disclosure, relates to a front edge of the temple that is connected to the frame. Consequently, when the eyewear apparatus is worn by the wearer, the proximal end of the temple is positioned proximally to the eye of the wearer. Such positioning of the charging interface at the first proximal end of the temple enables convenient connection of the charger to the eyewear apparatus, such as, by closing the temple with respect to the frame to expose the charging interface for connection of the charger, thereby, enabling convenient connection of the charger to the eyewear apparatus for recharging of the power source.

In summary, the eyewear apparatus (that can be, for example, autofocus glasses) comprises the electrical conductor disposed through a volume provided within a hinge portion of the eyewear apparatus, thereby, enabling compact, lightweight and aesthetic arrangement of the electrical conductor while ensuring protection of the electrical conductor from wear and tear and external damage.

### DETAILED DESCRIPTION OF DRAWINGS

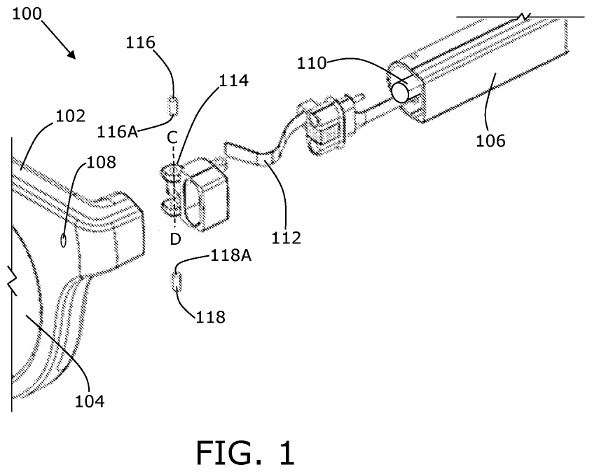

Referring to FIG. 1, there is shown an illustration of an exploded view of an eyewear apparatus 100 according to one embodiment of the present disclosure. The eyewear apparatus 100 comprises a frame 102. The eyewear apparatus 100 comprises at least one optical element 104 supported by the frame 102. The eyewear apparatus 100 comprises a temple 106. The eyewear apparatus 100 comprises at least one electrical component 108 associated with at least one of the at least one optical element 104 and the frame 102. The electrical component 108 is implemented as a light source associated with the frame 102. The eyewear apparatus 100 comprises a power source 110 housed inside the temple 106. The power source 110 supplies electricity to the at least one electrical component 108. The eyewear apparatus 100 comprises an electrical conductor 112 that connects the power source 110 to the at least one electrical component 108. The eyewear apparatus 100 comprises a first hinge 114 that couples the frame 102 and the temple 106. The first hinge 114 provides a first rotation point (such as a point along an axis CD) to allow rotation of the temple 106 with respect to the frame 102. The first hinge 114 comprises a first pin 116 and a second pin 118. The second pin 118 is disposed concentrically to the first pin 116 at a distance from the first pin 116. Further, a volume is provided between a first end 116A of the first pin 116 and a second end 118A of the second pin 118. The first end 116A of the first pin 116 and the second end 118A of the second pin 118 are facing towards each other. The electric conductor 112 passes through the volume.

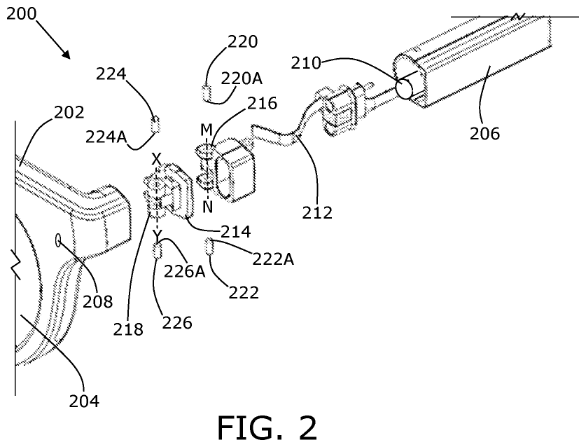

Referring to FIG. 2, there is shown an illustration of an exploded view of an eyewear apparatus 200 as per one embodiment of the present disclosure. The eyewear apparatus 200 comprises a frame 202. The eyewear apparatus 200 comprises at least one optical element 204 supported by the frame 202. The eyewear apparatus 200 comprises a temple 206. The eyewear apparatus 200 comprises at least one electrical component 208 associated with at least one of the at least one optical element 204 and the frame 202. As shown, the electrical component 208 is implemented as a light source associated with the frame 202. The eyewear apparatus 200 comprises a power source 210 housed inside the temple 206. The power source 210 supplies electricity to the at least one electrical component 208. The eyewear apparatus 200 comprises an electrical conductor 212 that connects the power source 210 to the at least one electrical component 208. The eyewear apparatus 200 comprises a rotating member 214. The eyewear apparatus 200 a first hinge 216 that couples the temple 206 to the rotating member 214. The first hinge 216 provides a first rotation point (such as a point along an axis MN) to allow rotation of the temple 206 with respect to the rotating member 214. The eyewear apparatus 200 comprises a second hinge 218 that couples the frame 202 to the rotating member 214. The second hinge 218 provides a second rotation point (such as a point along an axis XY) to allow rotation of the frame 202 with respect to the rotating member 214. The first hinge 216 comprises a first pin 220 and a second pin 222. The second pin 222 is disposed concentrically to the first pin 220 at a first distance from the first pin 220. Further, a first volume is provided between a first end 220A of the first pin 220 and a second end 222A of the second pin 222. The first end 220A of the first pin 220 and the second end 222A of the second 222 pin are facing towards each other. The electric conductor 212 passes through the first volume. The second hinge 218 comprises a third pin 224 and a fourth pin 226. The fourth pin 226 is disposed concentrically to the third pin 224 at a second distance from the third pin 224. Moreover, a second volume is provided between a third end 224A of the third pin 224 and a fourth end 226A of the fourth pin 226. The third end 224A of the third pin 224 and the fourth end 226A of the fourth pin 226 are facing towards each other. The electric conductor 212 passes through the second volume.

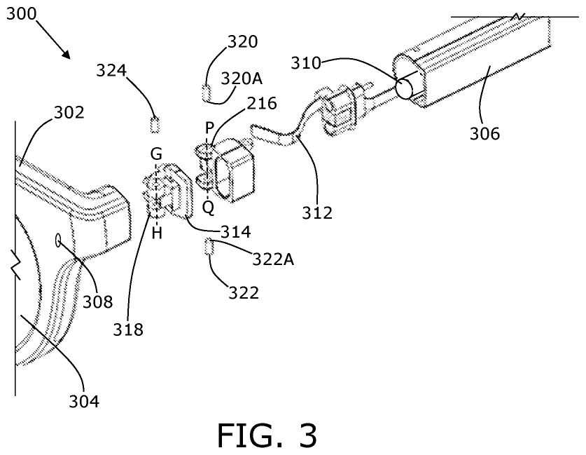

Referring to FIG. 3, there is shown an illustration of an exploded view of an eyewear apparatus 300 in accordance with an embodiment of the present disclosure. The eyewear apparatus 300 comprises a frame 302. The eyewear apparatus 300 comprises at least one optical element 304 supported by the frame 302. The eyewear apparatus 300 comprises a temple 306. The eyewear apparatus 300 comprises at least one electrical component 308 associated with at least one of the at least one optical element 304 and the frame 302. The electrical component 308 is implemented as a light source associated with the frame 302. The eyewear apparatus 300 comprises a power source 310 housed inside the temple 306. The power source 310 supplies electricity to the at least one electrical component 308. The eyewear apparatus 300 comprises an electrical conductor 312 that connects the power source 310 to the at least one electrical component 308. The eyewear apparatus 300 comprises a rotating member 314. The eyewear apparatus 300 a first hinge 316 that couples the temple 306 to the rotating member 314. The first hinge 316 provides a first rotation point (such as a point along an axis PQ) to allow rotation of the temple 306 with respect to the rotating member 314. The eyewear apparatus 300 comprises a second hinge 318 that couples the frame 302 to the rotating member 314. The second hinge 318 provides a second rotation point (such as a point along an axis GH) to allow rotation of the frame 302 with respect to the rotating member 314. The first hinge comprises 316 a first pin 320 and a second pin 322. The second pin 322 is disposed concentrically to the first pin 320 and at a distance from the first pin 320. Moreover, a first volume is provided between a first end 320A of the first pin 320 and a second end 322A of the second pin 322. The first end 320A of the first pin 320 and the second end 322A of the second pin 322 are facing towards each other. The electric conductor passes 312 through the first volume. Further, the second hinge 318 comprises a third pin 324. The electric conductor 312 passes around the third pin 324.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An eyewear apparatus comprising:
a frame;
at least one optical element supported by the frame;
a temple;
at least one electrical component is associated with at least one of: the at least one optical element, and the frame;
a power source housed inside the temple, wherein the power source supplies electricity to the at least one electrical component;
an electrical conductor connects the power source to the at least one electrical component; and
a first hinge couples the frame and the temple, wherein the first hinge provides a first rotation point to allow rotation of the temple with respect to the frame,
wherein the first hinge comprises a first pin and a second pin, wherein the second pin is disposed concentrically to the first pin at a distance from the first pin, and wherein a volume is provided between a first end of the first pin and a second end of the second pin, wherein the first end of the first pin and the second end of the second pin are facing towards each other, and wherein the electric conductor passes through the volume.

2. An eyewear apparatus comprising:
a frame;
at least one optical element supported by the frame;
a temple;
at least one electrical component is associated with at least one of: the at least one optical element, and the frame;
a power source housed inside the temple, wherein the power source supplies electricity to the at least one electrical component;
an electrical conductor connects the power source to the at least one electrical component;
a rotating member;
a first hinge couples the temple to the rotating member, wherein the first hinge provides a first rotation point to allow rotation of the temple with respect to the rotating member, and
a second hinge couples the frame to the rotating member, wherein the second hinge provides a second rotation point to allow rotation of the frame with respect to the rotating member,
wherein the first hinge comprises a first pin and a second pin, wherein the second pin is disposed concentrically to the first pin at a first distance from the first pin, and wherein a first volume is provided between a first end of the first pin and a second end of the second pin, wherein the first end of the first pin and the second end of the second pin are facing towards each other, and wherein the electric conductor passes through the first volume,
wherein the second hinge comprises a third pin and a fourth pin, wherein the fourth pin is disposed concentrically to the third pin at a second distance from the third pin, and wherein a second volume is provided between a third end of the third pin and a fourth end of the fourth pin, further wherein the third end of the third pin and the fourth end of the fourth pin are facing towards each other, and wherein the electric conductor passes through the second volume.

3. An eyewear apparatus comprising:
a frame;
at least one optical element supported by the frame;
a temple;
at least one electrical component is associated with at least one of: the at least one optical element, and the frame;
a power source housed inside the temple, wherein the power source supplies electricity to the at least one electrical component;
an electrical conductor connecting the power source to the at least one electrical component;
a rotating member;
a first hinge couples the temple to the rotating member, wherein the first hinge provides a first rotation point to allow rotation of the temple with respect to the rotating member, and
a second hinge coupling the frame to the rotating member, wherein the second hinge provides a second rotation point to allow rotation of the frame with respect to the rotating member,
wherein the first hinge comprises a first pin and a second pin, the second pin is disposed concentrically to the first pin and at a distance from the first pin, and wherein a first volume is provided between a first end of the first pin and a second end of the second pin, wherein the first end of the first pin and the second end of the second pin are facing towards each other, and wherein the electric conductor passes through the first volume, and
wherein the second hinge comprises a third pin, and wherein the electric conductor passes around the third pin.

4. The eyewear apparatus according to claim 1, wherein there is a frame attachment part fixed to the frame with the first hinge, and wherein the frame attachment part provides a first cam surface.

5. The eyewear apparatus according to claim 2, wherein the rotating member is linking the frame attachment part and the temple together, and wherein the rotating member is fixed to the temple and provides a second cam surface.

6. The eyewear apparatus according to claim 2, wherein there is a spring in connection to the rotating member for providing a spring force against the frame attachment part.

7. The eyewear apparatus according to claim 4, wherein the first cam surface and/or the second cam surface work against the spring force.

8. The eyewear apparatus according to claim 2, wherein the electrical conductor passes through a curved channel that extends past the first hinge and the second hinge, to minimize the bending of the electrical conductor during use.

9. The eyewear apparatus according to claim 8, wherein the curved channel is convex or concave, to support smooth bending of the electrical conductor.

10. The eyewear apparatus according to claim 8, wherein a first width of the curved channel at the first rotation point is larger than a second width of the curved channel at the second rotation point.

11. The eyewear apparatus according to claim 1, further comprises a charging interface, which is positioned at a first proximal end of the temple.
